(19) United States
(12) Patent Application Publication
(10) Pub. No.: US 2025/0219955 A1
(43) Pub. Date: Jul. 3, 2025

(54) SIGNALING TO IDENTIFY A STREAM CLASSIFICATION SERVICE (SCS) FLOW USING A FULLY QUALIFIED DOMAIN NAME/UNIFORM RESOURCE LOCATOR OR AN APPLICATION IDENTIFIER

(71) Applicant: Cisco Technology, Inc., San Jose, CA (US)

(72) Inventors: Binita Gupta, San Diego, CA (US); Brian D. Hart, Sunnyvale, CA (US); Malcolm M. Smith, Richardson, TX (US)

(73) Assignee: Cisco Technology, Inc., San Jose, CA (US)

(21) Appl. No.: 18/786,385

(22) Filed: Jul. 26, 2024

Related U.S. Application Data
(60) Provisional application No. 63/616,561, filed on Dec. 30, 2023.

(51) Int. Cl. H04L 47/2483; H04L 61/4511; H04W 48/16

(52) U.S. Cl. CPC H04L 47/2483; H04W 48/16; H04L 61/4511

(57) ABSTRACT

Signaling to identify a Stream Classification Service (SCS) flow using a Fully Qualified Domain Name (FQDN)/Uniform Resource Locator (URL) or an application Identifier (ID) may be provided. An Access Point (AP) may receive a SCS request from a station for a SCS flow. The SCS request may include a flow identifier for the SCS flow. The flow identifier may include a FDQN or an application ID for identifying the SCS flow. The AP may verify a network policy associated with the flow identifier for the SCS flow. The AP may process the SCS request for the SCS flow based on the network policy.

### RELATED APPLICATION

Under provisions of 35 U.S.C. § 119(e), Applicant claims the benefit of U.S. Provisional Application No. 63/616,561, filed Dec. 30, 2023, which is incorporated herein by reference.

### TECHNICAL FIELD

The present disclosure relates generally to signaling to identify a stream classification service flow using a fully qualified domain name/uniform resource locator or an application identifier.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various implementations of the present disclosure. In the drawings:

FIG. 1 is a block diagram of an operating environment;

FIG. 2 is a flow chart of a method for providing signaling to identify a Stream Classification Service (SCS) flow using a Fully Qualified Domain Name (FQDN)/Uniform Resource Locator (URL) or an application Identifier (ID);

FIG. 3 illustrates a structure of a classifier Type 10 of Table 9-201 of the Institute of Electrical and Electronics Engineers (IEEE) 802.11be standard;

FIG. 4A illustrates a SCS descriptor element of a SCS request frame;

FIG. 4B illustrates a public identifier Uniform Resource Identifier (URI)/FQDN sub-element format of a SCS descriptor element;

FIG. 5 is a flow chart of a method for providing a resource allocation and retention priority and a preemption indication for an SCS flow;

FIG. 6 is a flow chart of a method for providing a signaling mechanism for indicating Quality of Service (QOS) treatment for an Uplink (UL) flow; and

FIG. 7 is a block diagram of a computing device.

### DETAILED DESCRIPTION

### Overview

Signaling to identify a Stream Classification Service (SCS) flow using a Fully Qualified Domain Name (FQDN)/Uniform Resource Locator (URL) or an application Identifier (ID) may be provided. An Access Point (AP) may receive a SCS request from a station for a SCS flow. The SCS request may include a flow identifier for the SCS flow. The flow identifier may include a FDQN or an application ID for identifying the SCS flow. The AP may verify a network policy associated with the flow identifier for the SCS flow. The AP may process the SCS request for the SCS flow based on the network policy.

Resource allocation and retention priority and preemption indication for a SCS flow may be provided. An AP may receive a first SCS request for a first SCS flow. The first SCS request may comprise a first resource allocation and retention priority and a Quality of Service (QOS) resources for the first SCS flow. The AP may determine that there is a conflict for the QoS resources between the first SCS flow and a second SCS flow. The second SCS flow may be associated with a second resource allocation and retention priority. The AP may prioritize allocation of the QoS resources for the first SCS flow and the second SCS flow based on the first resource allocation and retention priority and the second resource allocation and retention priority.

A signaling mechanism to indicate network QoS treatment for a SCS flow may be provided. An AP may receive a SCS request from a station for an uplink stream. The AP may determine that the SCS request does not include a traffic classifier information for the uplink stream. The AP may send a SCS response having a status code to the station in response to determining that the SCS request does not comprise the traffic classifier information for the uplink stream. The status code may include one of a first status code indicating to the station that the SCS request is being rejected for lack of the traffic classifier information and a second status code indicating to the station that the SCS request is being accepted along with assigned quality of service characteristics.

Both the foregoing overview and the following example implementations are examples and explanatory only and should not be considered to restrict the disclosure's scope, as described and claimed. Furthermore, features and/or variations may be provided in addition to those described. For example, implementations of the disclosure may be directed to various feature combinations and sub-combinations described in the example implementations.

### Example Implementations

The following detailed description refers to the accompanying drawings Wherever possible, the same reference numbers are used in the drawings and the following description to refer to the same or similar elements. While implementations of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Streaming traffic is among the largest and fastest growing traffic on the internet. For example, use of videoconferencing, interactive gaming, voice, Extended Reality (XR), and Internet of Things (IoT) applications over Wireless Fidelity (WiFi) is experiencing a tremendous growth. These latency sensitive applications in WiFi networks may need a robust service delivery. Stream Classification Services (SCS) may enable classification and WiFi Quality of Service (QOS) treatment of specific traffic flows allowing some traffic flows to be prioritized over other traffic flows and QoS to be met.

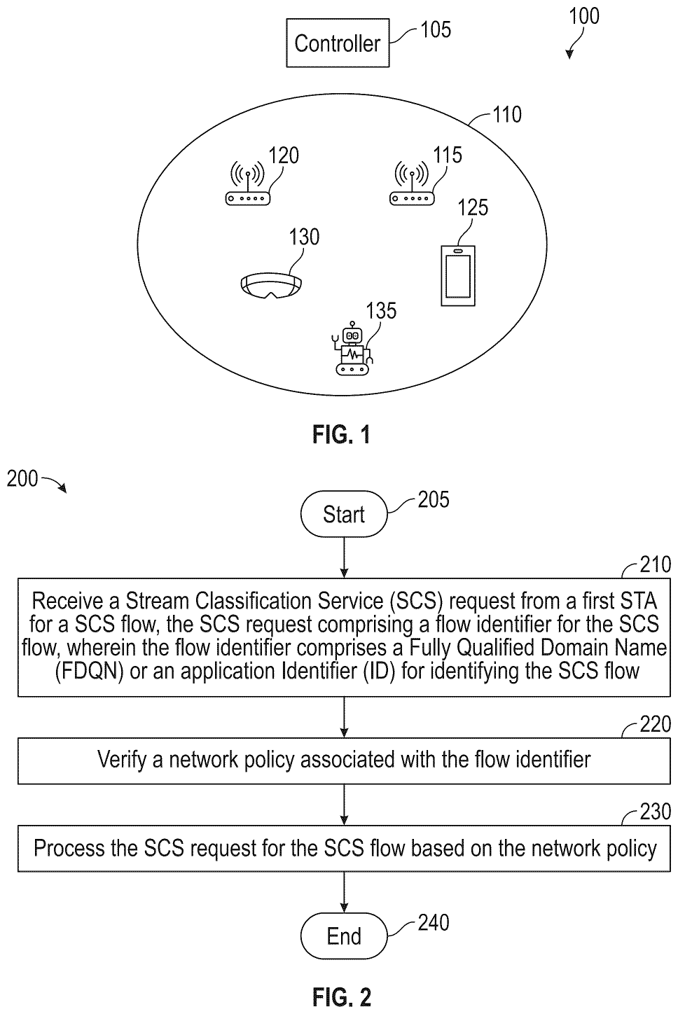

FIG. 1 shows an operating environment 100. As shown in FIG. 1, operating environment 100 may comprise a controller 105 and a coverage environment 110. Coverage environment 110 may comprise, but is not limited to, a Wireless Local Area Network (WLAN) comprising a plurality of APs that may provide wireless network access (e.g., access to the WLAN for client devices). The plurality of APs may include a first AP 115 and a second AP 120. The plurality of APs may provide wireless network access to a plurality of Stations (STAs) as they move within coverage environment 110. The plurality of STAs may comprise, but are not limited to, a first STA 125, a second STA 130, and a third STA 135. Ones of the plurality of STAs may comprise, but are not limited to, a smart phone, a Head Mounted Device (HMD), a mice, a keyboard, a personal computer, a tablet device, a mobile device, a telephone, a remote control device, a set-top box, a digital video recorder, an Internet-of-Things (IoT) device, a network computer, a router, Augmented Reality (AR)/Virtual Reality (VR)/XR devices, or other similar microcomputer-based device. Each of the plurality of APs may be compatible with specification standards such as, but not limited to, the Institute of Electrical and Electronics Engineers (IEEE) 802.11 specification standard for example.

The plurality of APs and the plurality of STAs may use Multi-Link Operation (MLO) where they simultaneously transmit and receive across different bands and channels by establishing two or more links to two or more AP radios. These bands may comprise, but are not limited the 2 GHz band, the 5 GHz band, the 6 GHz band, and the 60 GHz band.

Controller 105 may comprise a Wireless Local Area Network controller (WLC) and may provision and control coverage environment 110 (e.g., a WLAN). Controller 105 may allow first STA 125, second STA 130, and third STA 135 to join coverage environment 110. In some implementations of the disclosure, controller 105 may be implemented by a Digital Network Architecture Center (DNAC) controller (i.e., a Software-Defined Network (SDN) controller.

The elements described above of operating environment 100 (e.g., controller 105, first AP 115, second AP 120, first STA 125, second STA 130, or third STA 135) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 7, the elements of operating environment 100 may be practiced in a computing device 700.

### Signaling to Identify a SCS Flow Using a Fully Qualified Domain Name (FQDN)/Uniform Resource Locator (URL) or an Application Identifier (ID)

In the IEEE 802.11be standard, a SCS flow carried over a SCS stream may be identified using a Traffic Classifier (TCLAS) element. The TCLAS element may be used to identify a SCS flow via an Internet Protocol (IP) tuple by using a Classifier Type 4. However, there may be examples where a network policy may be defined for SCS flows based on a FQDN or an URL. For example, a network policy may categorize all SCS flows directed to ‘vr.xyz.com’ as a hard Service Level Agreement (SLA) to meet strict Quality of Service (QOS) requirements for an AR/VR application. Also, in some other examples, it may not be straightforward to determine the IP tuple for individual SCS flows. For such examples, it may be useful or preferable to define a network policy based on FQDNs or URLs. Also in some network policies, a SCS flow may be identified by an Operating System (OS) assigned application ID. For example, in an enterprise managed application database, SCS flows may be identified by their application ID and network policies may get defined for such applications based on application IDs.

To support enforcing a network policy that may be defined based on FQDN, URL, or an application ID, it may be desirable to extend a SCS request frame to support flow identification/classification based on the FQDN, the URL, and the application ID. This disclosure may provide such processes. For example, the processes disclosed here may to extend a SCS request frame to provide a FQDN, an URL, or an application ID as a flow identification for a SCS flow.

FIG. 2 is a flow chart setting forth the general stages involved in a method 200 consistent with implementations of the disclosure for signaling to identify a SCS flow using a FDQN/URL or an application ID. Method 200 may be implemented using first AP 115 and first STA 125 as described in more detail above with respect to FIG. 1. Ways to implement the stages of method 200 will be described in greater detail below.

Method 200 may begin at starting block 205 and proceed to stage 210 where first AP 115 may receive a SCS request from first STA 125 for a SCS flow. The SCS request may be received in a SCS request frame and may include a flow identifier. The flow identifier may comprise a FDQN, a URL, or an application ID for identifying the SCS flow. In some examples, the SCS request may comprise QoS resources requested or QoS characteristics for the SCS flow.

In one implementation, the FDQN or the application ID for the SCS flow may be provided in a TCLAS element of the SCS request. The TCLAS element definition in the IEEE 802.11be may include multiple frame Classifier Types as defined in the Table 9-201. Table 9-201 is reproduced below.

TABLE 9-201
Frame Classifier Type

| Classifier Type | Classifier Parameters |
|---|---|
| 0 | Ethernet parameters |
| 1 | TCP/UDP IP parameters |
| 2 | IEEE. 802.1Q-2003 parameters(Deprecated)(#56) |
| 3 | Filter Offset parameters |
| 4 | IP and higher layer parameters |
| 5 | IEE 802.1Q parameters(#56) |
| 6 | IEEE. 802.11 MAC header parameters |
| 7 | IEEE Std 802.11 downlink PV1 MPDU MAC header |
| | parameters (From DS field of the |
| | Frame Control field equal to 1) |
| 8 | IEEE Std 802.11 nondownlink PV1 MPDU MAC |
| | header parameters (from DS field of the |
| | Frame Control field equal to 0) |
| 9 | IEEE Std 802.11 PV1 MPDU Full |
| | Address MAC header parameters |
| 10 | IP extensions and higher layer parameters |
| 11-255 | Reserved |

As shown in the Table 9-201 above, Classifier Type 4 is used to provide the IP tuple information for a SCS flow, and the Classifier type 10 may be defined to include IP extensions and higher layer parameters. In example implementations, the Classifier Type 10 of Table 9-201 may be used to provide the FDQN/URL for the SCS flow.

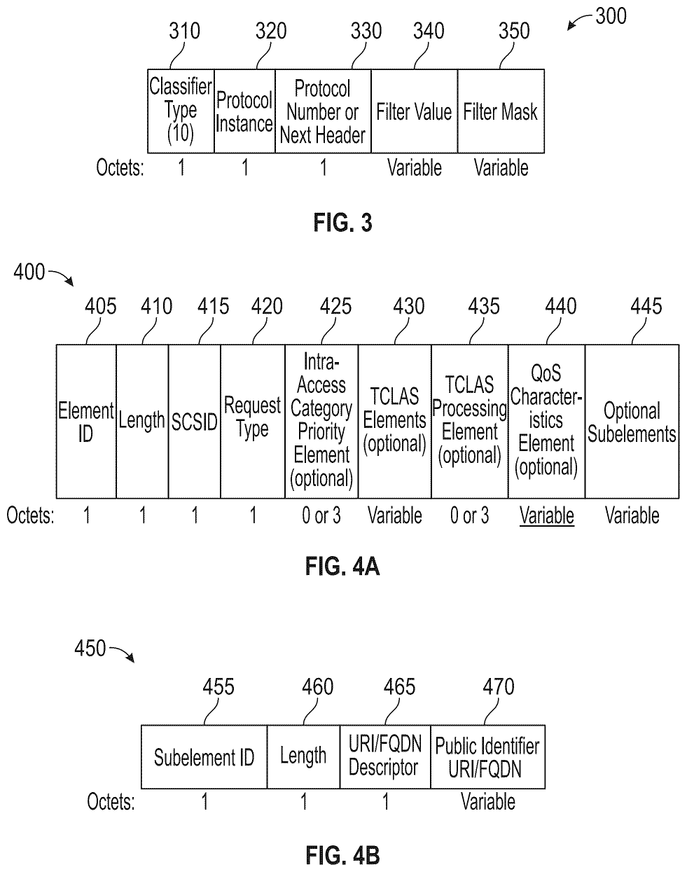

FIG. 3 illustrates a structure of the Classifier Type 10 of Table 9-201 of the IEEE 802.11be. As shown in FIG. 3, the Classifier Type 10 may include a classifier type field 310, a protocol instance field 320, a protocol number or a next header field 330, a filter value field 340, and a filter mask field 350. Each of classifier type field 310, protocol instance field 320, and protocol number or next header field 330 may be of a fixed length, for example, 1 octet long. Each of filter value field 340 and filter mask field 350 may be of a variable length.

To provide the FDQN/URL or the application ID for the SCS flow, protocol number or next header field 330 may be set to Transmission Control Protocol (TCP) (that is, the Classifier Type 6 of Table 9-201 of the IEEE 802.11be) since Hypertext Transfer Protocol (HTTP) may use TCP transport. In addition, filter value field 340 may be set to include the FQDN/URL as per the HTTP request message format. For example, filter value field 340 may be set to “GET VR.XYZ.COM”. In another implementation, the FQDN/URL may also include a port number. In such implementation, filter value field 340 may be set to “GET VR.XYZ.COM:2222”. Moreover, filter mask field 350 may be set to all 1 s. All 1 s in filter mask field 350 may indicate that every part of filter value field 340 may be compared for the flow identification.

In example implementations, the FQDN/URL information for the SCS flow may be provided in a public identifier Uniform Resource Identifier (URI)/FQDN sub-element as defined in the IEEE 802.11be in a SCS descriptor element of the SCS request frame. FIG. 4A illustrates a SCS descriptor element 400 of the SCS request frame. As shown in FIG. 4A, SCS descriptor element 400 of the SCS request frame may include an element ID field 405, a length field 410, a SCS ID field 415, a request type field 420, an intra-access category priority element (optional) field 425, a TCLAS elements field (optional) 430, a TCLAS processing element field (optional) 435, a QoS characteristics element field (optional) 440, and an optional sub-elements field 440. Each of element ID field 405, length field 410, SCS ID field 415, and request type field 420 may be 1 octet long. Each of intra-access category priority element field 425 and TCLAS processing element field 435 may be of a fixed length, for example, 0 or 3 octet long. Each of TCLAS elements field 430a, QoS characteristics element field 440, and optional sub-elements field 440 may be of a variable length.

FIG. 4B illustrates a public identifier URI/FQDN sub-element format 450. As shown in FIG. 4B, public identifier URI/FQDN sub-element format 450 may include a sub-element ID field 455, a length field 460, a URI/FQDN descriptor field 465, and a public identifier URI/FQDN field 470. Each of sub-element ID field 455, length field 460, and URI/FQDN descriptor field 465 may be of a fixed length, for example, 1 octet long. Public identifier URI/FQDN field 470 may be of a variable length.

In another example implementation, a new flow identification element may be defined to provide the FDQN/URL or application ID for the SCS flow. The IP-tuple based flow identification may also be included in the new flow identification element. The new flow identification element may be included as part of the SCS descriptor element in the SCS request frame of the SCS flow. First STA 125 may include multiple flow identification elements to provide multiple ways to identify the SCS flow. For example, first STA 125 may include both FQDN/URL and Application ID for the SCS flow.

The new flow identification element may include a flow identification type field and a flow identification information field. The flow identification type field may be of a fixed length, for example, 1 octet long and may include digits to indicate first AP 115 of a type of the flow identification being provided. For example, 0 may be used to indicate a FQDN/URL, 1 may be used to indicate an application ID, and 2 may be used to indicate an IP tuple. Multiple digits may be used when multiple type of flow identifications are being provided.

The new flow identification information field may be of a variable length and may include one or both of the following fields: a FQDN/URL field and an application ID information field. The application ID information field may include an OS specific application ID and an OS type. The flow identification element may further include an IP tuple information field. The IP tuple information field may include one or more of a source IP address, a destination IP address, a source port, and a destination port.

Referring back to FIG. 2, after receiving the SCS request from first STA 125 for the SCS flow at stage 210, method 200 may proceed to stage 220 where first AP 115 may verify a network policy associated with the flow identification. For example, first AP 115 upon receiving the SCS request with the FQDN/URL or the application ID, may use the FQDN/URL or the application ID to verify the network policy for the SCS flow.

Once having verified the network policy associated with the flow identification at stage 220, method 200 may proceed to stage 230 where first AP 115 may process the SCS request for the SCS flow based on the network policy. For example, based on the network policy, first AP 115 may accept the SCS request for the SCS flow if the network policy allows such flows. In addition, first AP 115 may assign the QoS resources requested for the SCS flow. First AP 115 may also use the FQDN/URL or the application ID to determine a configured traffic characteristics for the SCS flow if no QoS resources were requested in the SCS request. First AP 115 then may assign the QoS resources based on the determined configured traffic characteristics.

In one implementation, a FQDN/URL with a port number may be used to correlate to QoS characteristics on first AP 115 without explicitly receiving specific QoS characteristics for the SCS flow from first STA 125. For example, “www.xyz.com:2222” FQDN may be correlated to a video flow with a latency of 35 msec and a minimum data rate of 80 Mbps and the “www.xyz.com:4444” FQDN may be correlated to an audio flow with a latency of 20 msec and a minimum data rate of 1 Mbps. Correlating QoS characteristics may be used when a network may have a traffic SLA configured for specific SCS flows and an application on first STA 125 may not have detailed QoS characteristics provided to the Wi-Fi layer. In this example, first STA 125 may just send the FQDN of the SCS flow to first AP 115. The FDQN may then be used by first AP 115 to determine the QoS characteristics configured for the SCS flow on first AP 115. Once having processed the SCS request for the SCS flow based on the network policy at stage 230, method 200 may terminate at stage 240.

In an example implementation, the processes described above for flow identification using the FQDN/URL or the application ID may be used for DL and UL flows identification in an SCS request by first STA 125 or in an SCS response by first AP 115.

### Resource Allocation and Retention Priority and Preemption Indication for a SCS Flow

Multiple SCS flows may have similar traffic characteristics in terms of data rate and latency requirements as it may be originating from similar applications or similar devices. However, these applications or devices may have different level of priorities in the network. Traffic characteristics for these SCS flows may be signaled to an AP, for example, first AP 115, using a QoS characteristics element in the SCS request. First AP 115 may perform resource scheduling for these SCS flows (for example, Resource Unit (RU) allocation for Downlink (DL)/Uplink (UL) and UL trigger scheduling) based on the QoS characteristics element received in the SCS request.

The disclosure provides, for such SCS flows, processes to consider an application priority and other network defined policies (for example, business critical, hard SLA requirement etc.) when allocating link or QoS resources, besides the QoS characteristics received in the SCS request. Disclosed processes, therefore, may enable resource allocation and retention of QoS resources for the SCS flows to be prioritized as per the network/enterprise policy. To enable differentiating between resource allocation and resource retention for SCS flows that may have similar traffic characteristics as indicated in the QoS characteristics element in the SCS request, based on network/enterprise defined policy, following three parameters may be defined for a SCS flow. The first parameter may include a resource allocation and retention priority, the second parameter may include a resource preemption capability, and the third parameter may include a resource preemption validity. These parameters may be provided in the SCS request.

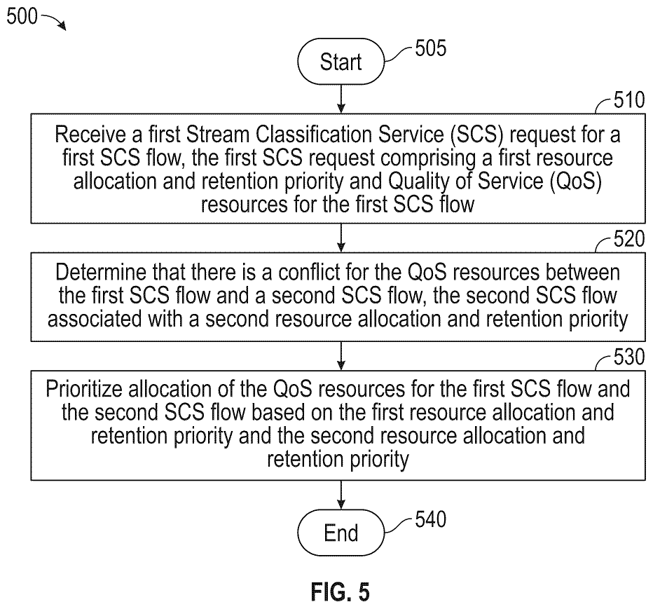

FIG. 5 is a flow chart setting forth the general stages involved in a method 500 consistent with implementations of the disclosure for resource allocation and retention priority and preemption indication for a SCS flow. Method 500 may be implemented using first AP 115 and first STA 125 as described in more detail above with respect to FIG. 1. Ways to implement the stages of method 500 will be described in greater detail below.

Method 500 may begin at starting block 505 and proceed to stage 510 where first AP 115 may receive a first SCS request for a first SCS flow. The first SCS request may include a first resource allocation and retention priority and QoS resources for the first SCS flow. The first resource allocation and retention priority may define a relative priority of the first SCS flow in terms of getting allocation of the QoS resources. In one implementation, a lower value of the resource allocation and retention priority may indicate a higher priority for the QoS resources allocation and retention. First AP 115 may support a defined set of priority values, for example, 16 or 32 levels of priority for SCS flows. Certain priority values, for example, values 1-8 may be reserved for critical SCS flow or high SLA flows as configured in the network policy. Other higher priority values may be used by SCS flows with soft SLA or no SLA.

In addition to the resource allocation and retention priority, the first SCS request may also include a first resource preemption capability parameter. The first resource preemption capability parameter may define whether the first SCS flow may have the capability to preempt QoS resources from other SCS flows, for example, from a lower priority SCS flow. The first resource preemption capability parameter may be either enabled or disabled. By default, the resource preemption capability parameter may be enabled for SCS flows with high priority levels. When an SCS request for a SCS flow is received for which this resource preemption capability parameter is enabled in the network policy, and if enough QoS resources are not available, then the SCS flow may preempt and take away already allocated QoS resources from one or more lower priority SCS flows, for which the resource preemption vulnerability indicator is enabled. This may lead to some SCS requests being terminated/deactivated or paused at first AP 115 due to QoS resources being taken away.

The first SCS request may further include a first resource preemption vulnerability parameter. The first resource preemption vulnerability parameter may define whether the first SCS flow is subject to loosing already assigned QoS resources to higher priority SCS flows. When an SCS request is made for a higher priority flow and first AP 115 may not have enough QoS resources to admit that SCS flow, first AP 115 may take away assigned QoS resources from lower priority SCS flows for which the resource preemption vulnerability parameter is enabled. By default, the resource preemption vulnerability parameter may be enabled for SCS flows with no SLA.

These parameters, that is, the first resource allocation and retention priority, the first resource preemption vulnerability parameter, and the first resource preemption vulnerability parameter may be defined specific to the first SCS flow identified by a TCLAS (IP tuple) or a FQDN in the network policy. These parameters may be assigned by an End-to End (E2E) SLA mechanism, for example, by an administrator based on hard/soft SLA or business critical/non-business critical category for specific SCS flows. In some examples, these parameters may be set at controller 105 or another management entity in the network and propagated to first AP 115. First AP 115 may then consider these parameters for admission control, resource QoS allocation, and scheduling of SCS flows. In an implementation, one or more of these resource allocation related parameters may be defined per device. For example, a device identified as a premium STA may be given a higher value for the resource allocation and retention priority.

Once having received the first SCS request for the first SCS flow at stage 510, method 500 may proceed to stage 520 where first AP 115 may determine that there is a conflict for the QoS resources between the first SCS flow and a second SCS flow. The second SCS flow may be associated with a second resource allocation and retention priority. The conflict may occur when multiple SCS flows are competing for the same or similar QoS resources at first AP 115 and first AP 115 may not have enough QoS resources to meet needs of each of these multiple flows.

In some examples, the second SCS request for the second SCS flow may be received at the same time as the first SCS request. In some other examples, both the first SCS request and the second SCS request may be received from a same STA (that is, first STA 125) or two different STAs (that is, first STA 125 and second STA 130). The second SCS flow may also be associated with a second resource preemption capability parameter and a second resource preemption vulnerability parameter.

In response to determining that there is a conflict for the QoS resources between the first SCS flow and the second SCS flow at stage 520, method 500 may proceed to stage 530 where first AP 115 may prioritize allocation of the QoS resources for the first SCS flow and the second SCS flow based on the first resource allocation and retention priority and the second resource allocation and retention priority. For example, if both the first SCS request and the second SCS request were received at the same time and the first resource allocation and retention priority is higher than the second resource allocation and retention priority, first AP 115 may prioritize allocation of the QoS resources to the first SCS flow and reject the second SCS request for the second SCS flow. In another example, when the first SCS request is received and first AP 115 may not have enough QoS resources to admit that the first SCS flow, first AP 115 may take away assigned QoS resources for the second SCS flow if the first resource allocation and retention priority is higher than the second resource allocation and retention priority and the second resource preemption vulnerability parameter is enabled. Once first AP 115 prioritizes the allocation of the QoS resources for the first SCS flow and the second SCS flow at stage 530, method 500 may then end at stage 540.

In an example implementation, the SCS request may be enhanced to use the three parameters discussed above for UL flows. First AP 115, for example, may send these three per flow specific resource allocation related parameters to first STA 125 in a SCS response, if first AP 115 may have a different setting for these parameters across multiple flows from first STA 125. These parameters may be sent in a new sub-element, for example, a resource allocation priority sub-element, in a SCS descriptor element. First STA 125 may consider these parameters in prioritizing UL resource scheduling at first STA 125 across those SCS flows. In another implementation, based on a network policy, these parameters may be defined for other SCS flows as well besides SCS flows for which the QoS characteristics may be indicated in the SCS request. First AP 115 may send these parameters to first STA 125 for differentiating resource allocation for these SCS flows in the UL via an unsolicited management frame for setting the policy for UL resource allocation or by enhancing the Differentiated Service Code Point (DSCP) policy message defined in a QoS management.

### Signaling Mechanism to Indicate Network QoS Treatment for a SCS Flow

A SCS request as defined in the IEEE 802.11be may not include TCLAS information (for example, IP tuple information) to provide identification of an UL flow. The SCS request may be enhanced to include the TCLAS information for the UL flow to identify that UL flow. Even with the SCS enhancement to include the TCLAS information, an STA, for example, first STA 125 may not be mandated to include the TCLAS information for the UL flow, and hence may or may not send the TCLAS information in an SCS request.

If no TCLAS information is received in an SCS request, an AP, for example, first AP 115 may not be able to identify the UL flow at the time when the SCS request is received. As a result, first AP 115 or controller 105 may not be able to perform a flow specific policy verification for that UL flow. In addition, first AP 115 may not be able to configure QoS resources of that UL flow on other network nodes per flow QoS characteristics requirement for an End-to-End (E2E) SLA. In such cases, the UL flow corresponding to the SCS request may get a default QoS treatment in the network, even if the UL flow may be a higher priority flow, for example, an AR/VR flow. This may impact the E2E QoS for the UL flow. Hence, SCS signaling may be enhanced to enable first AP 115 to be able to signal to first STA 125 that the TCLAS information is required for a UL flow for QoS prioritization of that UL flow in the network.

The processes disclosed herein may provide an enhancement to SCS signaling mechanism to enable first AP 115 to signal to first STA 125 that the TCLAS information may be needed for a UL flow. The SCS signaling may be enhanced by using status codes. The status codes may signal to first STA 125 that the TCLAS information is required for QoS prioritization of the UL flow.

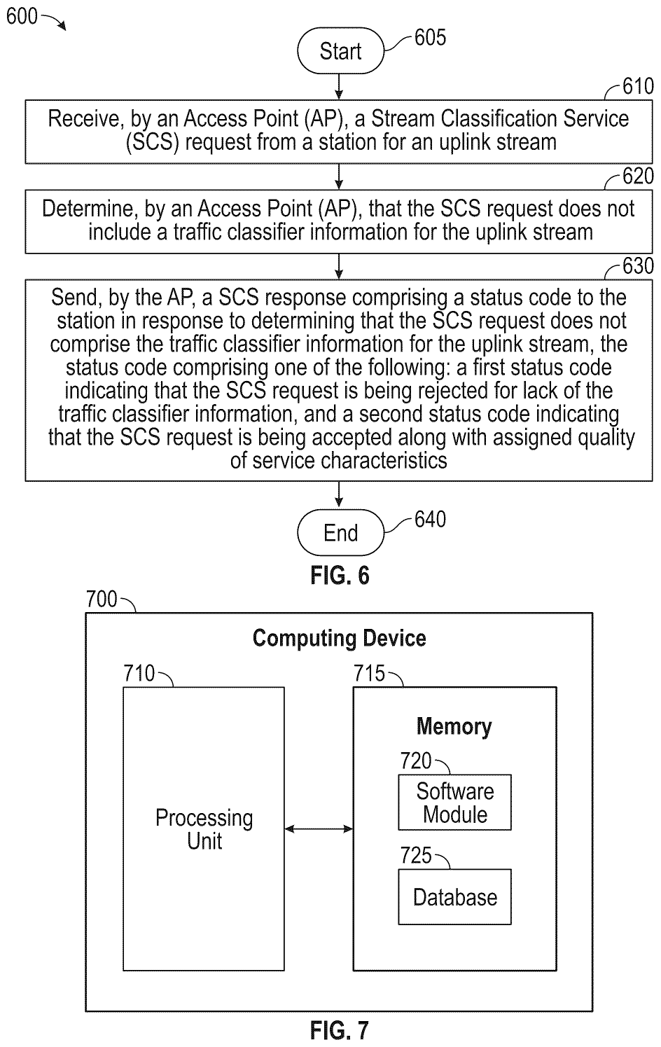

FIG. 6 is a flow chart setting forth the general stages involved in a method 600 consistent with implementations of the disclosure for a signaling mechanism to indicate network QoS treatment for a UL flow. Method 600 may be implemented using first AP 115 and first STA 125 as described in more detail above with respect to FIG. 1. Ways to implement the stages of method 600 will be described in greater detail below.

Method 600 may begin at starting block 505 and proceed to stage 610 where first AP 115 may receive a SCS request from first STA 125 for a UL flow. The UL flow may be an SCS flow associated with the SCS request. The SCS request may include QoS characteristics or QoS resources requested for the UL flow.

After receiving the SCS request for the UL flow from first STA 125 at stage 610, method 600 may proceed to stage 620 where first AP 115 may determine that the SCS request does not contain TCLAS information for the UL flow.

Once having determined that the SCS request does not include the TCLAS information for the UL flow at stage 620, method 600 may proceed to stage 630 where first AP 115 may send a SCS response comprising a status code to first STA 125 in response to determining that the SCS request does not include the TCLAS information for the UL flow. The status code may include one of a first status code and a second status code. The first status code may indicate that the SCS request is being rejected for lack of the TCLAS information. The second status code may indicate that the SCS request is being accepted. The second code may also include an assigned TCLAS information and an assigned QoS characteristics.

For example, when first AP 115 receives the SCS request with QoS characteristics for the UL flow, but with no TCLAS information, first AP 115 may reject the SCS request for lack of TCLAS information identifying that UL flow. As discussed above, the TCLAS information may be needed for policy verification and for QoS prioritization of the UL flow in the network. Hence, in some implementations, a network policy may forbid first AP 115 from accepting SCS requests with no TCLAS information. First AP 115 may send the first status code in the SCS response indicating that the TCLAS information is required to accept the SCS request, and the SCS request is being rejected because the TCLAS information is missing from the received SCS request. In an example, the first code may be defined as:

### SCS_Rejected_Flow_TCLAS_Required

First STA 125 upon receiving the SCS response with the first status code, may send another SCS request or resent the SCS request with one or more TCLAS elements for the UL flow. The new SCS request may include the same QoS characteristics or different QoS characteristics from the previous or original SCS request.

In some implementations, first AP 115 may be able to accept the SCS request with no TCLAS information for the UL flow when the network policy allows first AP 115 to accept such SCS request. In such implementations, first AP 115 may assign default QoS characteristics for the UL flow and include that in the SCS response. First AP 115 may send the SCS response that may include the second status code. The second status code may indicate to first STA 125 that the SCS request is being accepted and the UL flow may receive the default QoS characteristics as indicated by the DSCP value in the TCLAS information included in the SCS response. The second code may also include an assigned TCLAS information and an assigned QoS characteristics.

The second code may also indicate that first STA 125 is recommended to send another SCS request or resend the SCS request with TCLAS information (for example, an IP tuple) identifying the UL flow to receive the QoS characteristics. In an example, the second status code may be defined as:

SCS_Accepted_Network_QOS_Indicated_Resend_with_Flow_TCLAS_F or_Finer_QOS.

First STA 125 upon receiving the SCS response with the second status code may send another SCS request or resend the SCS request with TCLAS information identifying the UL flow. The new SCS may include the same QoS characteristics or different QoS characteristics as the previous or original SCS request.

In some implementations, first AP 115 may apply network policies defined based on DSCP values. Such DSCP values may be defined based on metal levels (for example, Platinum, Gold, Silver, Bronze, etc.) where each metal level may define a DSCP ceiling value for QoS treatment. First AP 115 may indicate to first STA 125 to provide a DSCP value for the SCS flow using TCLAS element to verify the DSCP based network policy defined in the network before accepting the SCS request. In this example, first AP 115 may send a third status code in the SCS response. The third status code may indicate that the SCS request is rejected because the SCS request does not contain a DSCP value and that the DSCP value may be required as per the network policy. In an example, the third status code may be defined as:

### SCS_Rejected_DSCP_TCLAS_Required.

First STA 125 upon receiving the SCS response with the third status code may send another SCS request with the DSCP value for the UL flow. The DSCP value may be included in the TCLAS with or without IP tuple information. Once first AP 115 may send the SCS response comprising the status code at stage 630, method 600 may then end at stage 640.

FIG. 7 shows computing device 700. As shown in FIG. 7, computing device 700 may include a processing unit 710 and a memory unit 715. Memory unit 715 may include a software module 720 and a database 725. While executing on processing unit 710, software module 720 may perform, for example, processes for signaling to identify a SCS flow using a FDQN/URL or an application ID as described above with respect to FIG. 2, resource allocation and retention priority and preemption indication for an SCS flow as described above with respect to FIG. 5, and a signaling mechanism to indicate network QoS treatment for a SCS flow as described above with respect to FIG. 6. Computing device 700, for example, may provide an operating environment for controller 105, first AP 115, second AP 120, first STA 125, second STA 130, or third STA 135. Controller 105, first AP 115, second AP 120, first STA 125, second STA 130, or third STA 135 may operate in other environments and are not limited to computing device 700.

Computing device 700 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 700 may comprise any computer operating environment, such as hand-held devices, multiprocessor systems, microprocessor-based or programmable sender electronic devices, minicomputers, mainframe computers, and the like. Computing device 700 may also be practiced in distributed computing environments where tasks are performed by remote processing devices. The aforementioned systems and devices are examples, and computing device 700 may comprise other systems or devices.

Implementations of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, implementations of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain implementations of the disclosure have been described, other implementations may exist. Furthermore, although implementations of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, implementations of the disclosure may be practiced in an electrical circuit comprising discrete electronic elements, packaged or integrated electronic chips containing logic gates, a circuit utilizing a microprocessor, or on a single chip containing electronic elements or microprocessors. Implementations of the disclosure may also be practiced using other technologies capable of performing logical operations such as, for example, AND, OR, and NOT, including but not limited to, mechanical, optical, fluidic, and quantum technologies. In addition, implementations of the disclosure may be practiced within a general purpose computer or in any other circuits or systems.

Implementations of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to implementations of the disclosure, may be performed via application-specific logic integrated with other components of computing device 700 on the single integrated circuit (chip).

Implementations of the present disclosure, for example, are described above with reference to block diagrams and/or operational illustrations of methods, systems, and computer program products according to implementations of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for implementations of the disclosure.

What is claimed is:

1. A method comprising:
receiving, by an Access Point (AP), a Stream Classification Service (SCS) request from a station for a SCS flow, the SCS request comprising a flow identifier for the SCS flow, wherein the flow identifier comprises a Fully Qualified Domain Name (FDQN) or an application Identifier (ID) for identifying the SCS flow;
verifying, by the AP, a network policy associated with the flow identifier for the SCS flow; and
processing, by the AP, the SCS request for the SCS flow based on the network policy.

2. The method of claim 1, wherein processing the SCS request comprises determining a quality of service characteristics associated with the flow identifier received in the SCS request.

3. The method of claim 1, wherein the FDQN or the application ID is provided in a sub-element of a SCS descriptor element of the SCS request.

4. The method of claim 1, wherein the FDQN or the application ID is provided in a public identifier FQDN sub-element in a SCS descriptor element of the SCS request.

5. The method of claim 1, wherein the FDQN or the application ID is provided in a classifier type 10 field of a traffic classifier element of the SCS request.

6. The method of claim 1, wherein verifying the network policy associated with the flow identifier for the SCS flow comprises:
determining the network policy associated with the flow identifier; and
verifying that the network policy associated with the flow identifier allows the SCS flow.

7. The method of claim 1, wherein processing the SCS request for the SCS flow comprises determining that the AP can support QoS resources requested for the SCS flow.

8. The method of claim 1, wherein the application ID comprises an operating system assigned application ID and an operating system type.

9. A method comprising:
receiving, by an Access Point (AP), a first Stream Classification Service (SCS) request for a first SCS flow, the first SCS request comprising a first resource allocation and retention priority and a Quality of Service (QOS) resources for the first SCS flow;
determining, by the AP, that there is a conflict for the QoS resources between the first SCS flow and a second SCS flow, wherein the second SCS flow is associated with a second resource allocation and retention priority; and
prioritizing, by the AP, allocation of the QoS resources for the first SCS flow and the second SCS flow based on the first resource allocation and retention priority and the second resource allocation and retention priority.

10. The method of claim 9, wherein each of the first resource allocation and retention priority and the second resource allocation and retention priority is assigned based on a service level agreement associated with the first SCS flow and the second SCS flow respectively.

11. The method of claim 9, wherein each of the first resource allocation and retention priority and the second resource allocation and retention priority is assigned based on a priority of an application or a device associated with the first SCS flow and the second SCS flow respectively.

12. The method of claim 9, wherein the first SCS request further comprises a first resource preemption capability parameter, wherein the first resource preemption capability parameter defines whether the first SCS flow has a capability to preempt other QoS resources from other SCS flows.

13. The method of claim 12, wherein the first resource preemption capability parameter is either enabled or disabled, and wherein when enabled, the first SCS flow has the capability to preempt the other QoS resources from a lower priority SCS flow.

14. The method of claim 9, wherein the first SCS request further comprises a first resource preemption vulnerability parameter, wherein the first resource preemption vulnerability parameter defines whether the first SCS flow is subject to loosing already assigned QoS resources to higher priority SCS flows.

15. The method of claim 14, wherein the first resource preemption vulnerability parameter is enabled for SCS flows with no associated service level agreement.

16. A method comprising:
receiving, by an Access Point (AP), a Stream Classification Service (SCS) request from a station for an uplink stream;
determining, by the AP, that the SCS request does not include a traffic classifier information for the uplink stream; and
sending, by the AP, a SCS response comprising a status code to the station in response to determining that the SCS request does not comprise the traffic classifier information for the uplink stream, the status code comprising one of:
a first status code indicating to the station that the SCS request is being rejected for lack of the traffic classifier information, and
a second status code indicating to the station that the SCS request is being accepted along with assigned quality of service characteristics.

17. The method of claim 16, wherein sending, by the AP, the SCS response comprising the status code in response to determining that the SCS request does not include the traffic classifier information for the uplink stream comprises:
sending, by the AP, the SCS response comprising the first status code in response to determining that:
the SCS request does not include the traffic classifier information for the uplink stream, and
a network policy requires the traffic classifier information to accept the SCS request.

18. The method of claim 16, wherein sending, by the AP, the SCS response comprising the status code in response to determining that the SCS request does not include the traffic classifier information for the uplink stream comprises:
sending, by the AP, the SCS response comprising the second status code in response to determining that:
the SCS request does not include the traffic classifier information for the uplink stream, and
a network policy does not require the traffic classifier information to accept the SCS request.

19. The method of claim 16, further comprising sending, by the AP, the SCS response comprising a third status code to the station in response to determining that the SCS request does not comprise a differentiated service code point value in the SCS request.

20. The method of claim 16, wherein the assigned quality of service characteristics is a default quality of service characteristics defined for SCS requests with no quality of service characteristics.
